(19) United States
(12) Patent Application Publication
(10) Pub. No.: US 2025/0096225 A1
(43) Pub. Date: Mar. 20, 2025

(54) CALENDERING OF ELECTRODES WITH ENHANCED EDGE QUALITY

(71) Applicant: GM GLOBAL TECHNOLOGY OPERATIONS LLC, DETROIT, MI (US)

(72) Inventors: Nicole Ellison, Southfield, MI (US); Joel G. Toner, Imlay City, MI (US); Xiaosong Huang, Novi, MI (US); Daniel Ryan, Fenton, MI (US)

(21) Appl. No.: 18/469,720

(22) Filed: Sep. 19, 2023

(51) Int. Cl. H01M 4/04

(52) U.S. Cl. CPC H01M 4/0435; H01M 4/0409

(57) ABSTRACT

Aspects of the disclosure include an electrode calendering system for manufacturing electrodes with enhanced edge quality. An exemplary system includes an active material supply including an electrode material and a coating roll coupled to the active material supply. The coating roll is positioned to coat a current collector with the electrode material. A back roll is positioned to transfer the current collector to the coating roll. The system includes at least one of a bare foil supporting material roll and a coated foil supporting material roll. The bare foil supporting material roll is positioned to apply a support material onto a first portion of the current collector prior to the current collector being coated with the electrode material. The coated foil supporting material roll is positioned to apply the support material onto the first portion of the current collector after the current collector is coated with the electrode material.

### INTRODUCTION

The present disclosure relates to battery cell manufacturing, and particularly to the calendering of electrodes with enhanced edge quality.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors can be added to provide a higher specific conductance and can increase the available contact area to minimize the interfacial contact resistance between the electrode and its terminal.

A current collector is typically a sheet of conductive material to which the active electrode material is attached. Aluminum foil, stainless steel, and titanium foil are commonly used as the current collector of an electrode. In some electrode fabrication processes, for example, a film that includes activated carbon powder (i.e., the active electrode material) is attached to a thin aluminum foil using an adhesive layer. To improve the quality of the interfacial bond between the film of active electrode material and the current collector, the combination of the film and the current collector is processed in a pressure laminator, for example, a calender. This process is generally known as calendering. Thus, the fabrication of an electrode typically involves the production of an active electrode material film and the lamination of that film onto a current collector.

### SUMMARY

In one exemplary embodiment a system is designed for manufacturing electrodes with enhanced edge quality. The system includes an active material supply including an electrode material and a coating roll coupled to the active material supply. The coating roll is positioned to coat a current collector with the electrode material. A back roll is positioned to transfer the current collector to the coating roll. The system includes at least one of a bare foil supporting material roll and a coated foil supporting material roll. The bare foil supporting material roll is positioned to apply a support material onto a first portion of the current collector prior to the current collector being coated with the electrode material. The coated foil supporting material roll is positioned to apply the support material onto the first portion of the current collector after the current collector is coated with the electrode material. The support material is applied at a thickness selected to evenly distribute stress across bare portions and coated portions of the current collector during a calendering process, thereby forming a pressed electrode having enhanced edge quality.

In addition to one or more of the features described herein, in some embodiments, one or more collection rollers are positioned to recover the support material after the calendering process. In some embodiments, the one or more collection rollers includes a top support material rewind roller positioned to recover the support material from a top surface of the pressed electrode. In some embodiments, the one or more collection rollers further includes a bottom support material rewind roller positioned to recover the support material from a bottom surface of the pressed electrode.

In some embodiments, the support material includes one or more of a polyimide, a polymer, a silicone-based adhesive, polytetrafluoroethylene (PTFE), polyvinyl chloride (PVC), and metal foil.

In some embodiments, the system includes a comma roll separated from the coating roll by a gap. The gap defines an amount of the electrode material coated onto the current collector.

In another exemplary embodiment a method is provided for manufacturing electrodes with enhanced edge quality. The method includes providing a current collector, applying a support material onto a first portion of the current collector, coating the current collector and the support material with an electrode material, calendering the current collector, the support material, and the electrode material, and removing the support material from the first portion of the current collector.

In some embodiments, the support material is applied at a thickness selected to evenly distribute calendering stress across bare portions and coated portions of the current collector.

In some embodiments, the method includes applying additional support material over the first portion of the current collector after calendering. In some embodiments, the additional support material is applied directly onto the electrode material.

In some embodiments, the support material comprises one or more of a polyimide, a polymer, a silicone-based adhesive, PTFE, PVC, and metal foil.

In some embodiments, applying the support material onto the first portion of the current collector includes providing a bare foil supporting material roll positioned to apply the support material onto the first portion of the current collector prior to the current collector being coated with the electrode material.

In some embodiments, coating the current collector and the support material with the electrode material includes providing an active material supply including the electrode material and providing a coating roll coupled to the active material supply. The coating roll is positioned to coat the current collector with the electrode material.

In yet another exemplary embodiment a method for manufacturing electrodes with enhanced edge quality can include providing a current collector, coating a first portion of the current collector with an electrode material, applying a support material onto a second portion of the current collector, calendering the current collector, the support material, and the electrode material, and removing the support material from the second portion of the current collector.

In some embodiments, the support material is applied at a thickness selected to evenly distribute calendering stress across the first portion and the second portion of the current collector.

In some embodiments, the support material includes one or more of a polyimide, a polymer, a silicone-based adhesive, PTFE, PVC, and metal foil.

In some embodiments, applying the support material onto the second portion of the current collector includes providing a coated foil supporting material roll positioned to apply the support material onto the second portion of the current collector after the first portion of the current collector is coated with the electrode material.

In some embodiments, coating the first portion of the current collector with the electrode material includes providing an active material supply including the electrode material and providing a coating roll coupled to the active material supply. The coating roll is positioned to coat the current collector with the electrode material.

In some embodiments, removing the support material includes providing a top support material rewind roller positioned to recover the support material from a top surface of the current collector.

In some embodiments, removing the support material further includes providing a bottom support material rewind roller positioned to recover the support material from a bottom surface of the current collector.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example configuration of an electrode coating system in accordance with one or more embodiments;

FIG. 3 is an example configuration of an electrode calendering system in accordance with one or more embodiments;

FIG. 4 is a process workflow for manufacturing electrodes with enhanced edge quality in accordance with one or more embodiments;

FIG. 5 is another process workflow for manufacturing electrodes with enhanced edge quality in accordance with one or more embodiments;

FIG. 6 is a flowchart in accordance with one or more embodiments; and

FIG. 7 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of the final integrated device (e.g., a battery). A current collector typically includes a sheet of conductive material (e.g., aluminum foil) to which an active electrode material is attached. To improve the quality of the interfacial bond between the film of the active electrode material and the current collector, the combination of the film and the current collector is processed in a pressure laminator. Thus, the fabrication of an electrode typically involves the production of an active electrode material film and the lamination of that film onto a current collector (the so-called calendering process).

Calendering can be generally defined as the compression of a dried electrode (the latter typically resulting from the coating and drying of an electrode slurry) to reduce its porosity, improve particle contact, and enhance energy or power density. Conventional calendering processes have been used to improve various aspects of battery technology by offering, for example, a higher specific conductance, greater contact areas, and lower contact resistance in the electrode. There are several challenges, however, in optimizing the calendering process.

One such challenge, for example, is that the calendering of electrodes (e.g., cathodes) onto current collector substrates (e.g., foil substrates such as aluminum, stainless steel, and titanium) produces a wrinkling defect when targeting lower porosities. Wrinkling defects are found at the interface between the coated sections of the current collector (i.e., those portions having pressed electrode films) and the uncoated sections (i.e., bare sections of the current collector) and are caused due to the different material properties of the electrode and substrate materials. These defects worsen as the resultant porosity decreases, meaning that relatively lower porosity electrodes natively suffer from more pervasive wrinkling defects.

While there are several approaches to mitigating wrinkling defects, each comes with of some tradeoff. For example, the naïve approach is to raise the porosity target, resulting in a proportional reduction in wrinkling defects but with decreased electrode conductivity. Another approach is to fully cover the substrate, so that there is no interface at which wrinkle defects can occur. The trade off here is that bare foil sections of the current collector (i.e., those portions not covered with the active electrode material) are ideal for use as battery terminals, and simply removing the bare foil sections reduces battery efficiencies.

This disclosure introduces a new electrode calendering system and process for manufacturing electrodes with enhanced edge quality. Rather than raising porosity targets or removing (or reducing) the bare foil portions of an electrode, an electrode calendering process described herein leverages support materials to evenly distribute stress during the calendering process. In some embodiments, a layer of support material is applied directly to the bare portions of a current collector. The support materials can be applied before or after coating portions of the current collector with active electrode material (i.e., the electrode coating or film). The support materials can be designed to have a thickness that mimics the coating thickness, dependent on current collector strength properties, of the electrode film pressed onto the current collector substrate. The current collector, electrode coating, and support materials are then subjected to the calendering process, during which the presence of the layer of support material ensures that the stress applied to the bare foil portions of the current collector is the same as the stress applied by the electrode coating to the coated portion of the current collector. After calendering, the layer of support material can be removed. In this manner, wrinkling defects can be reduced and edge quality can be increased without sacrificing porosity targets and/or bare foil surface area. In some embodiments, a second layer of support material is applied over the first layer of support material after the calendering process to support the first layer during the support material removal process, further improving edge quality.

Leveraging support materials when manufacturing electrodes in accordance with one or more embodiments offers several technical advantages over prior designs. Notably, the modified manufacturing process described herein can be used to produce electrodes without (or with greatly reduced) wrinkling defects. Batteries built from electrodes without wrinkles deliver a range of improved battery characteristics, as wrinkles can reduce electrode integrity (e.g., wrinkles can lead to poor adhesion between the coated electrode film and the current collector, resulting in regions of relatively weak attachment that are prone to delamination or peeling), increase electrical resistance (wrinkles can create gaps or areas of reduced contact between the electrode material and the current collector that can impede the flow of electrons), increase degradation and reduce cycle life (electrodes with wrinkles can experience increased stress and strain during charge-discharge cycles due to inconsistent mechanical properties, which can lead to accelerated degradation, cracking, or even electrode failure), increase thermal instabilities (wrinkles can trap electrolytes and inhibit heat dissipation, resulting in localized hotspots that can degrade the electrolyte), and reduce capacity and energy density (wrinkling defects can lead to uneven thickness distributions across the electrode surface and these non-uniformities can result in reduced active material utilization, lower capacity, and compromised energy density in the battery). Other advantages are possible. For example, while a roll press can be constructed de novo to incorporate support material application and removal, aspects of the present disclosure can be leveraged to modify existing roll presses to reduce wrinkle defects without comma roll, coating roll, and/or back roll redesigns.

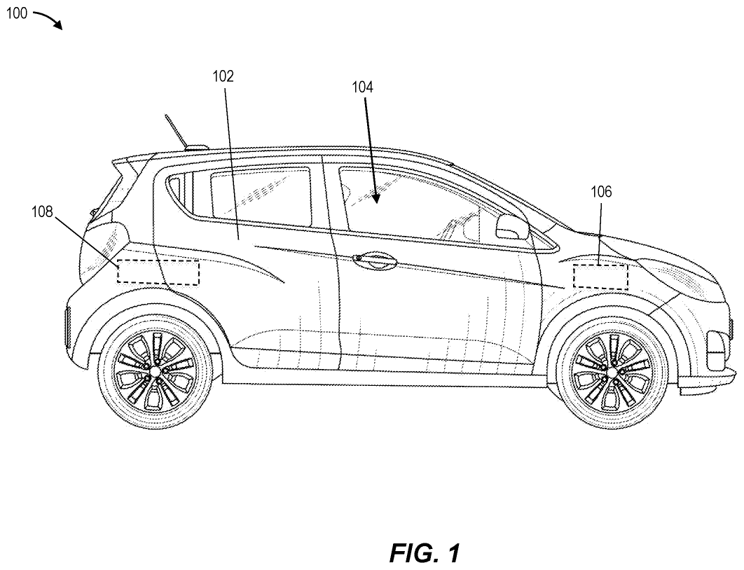

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

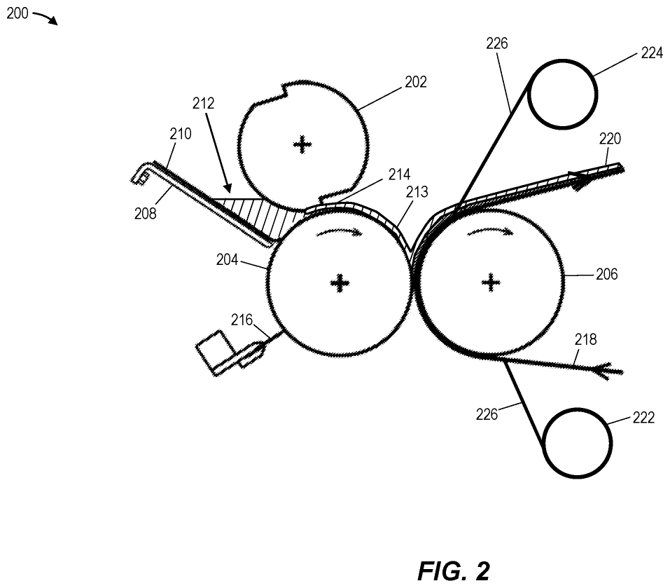

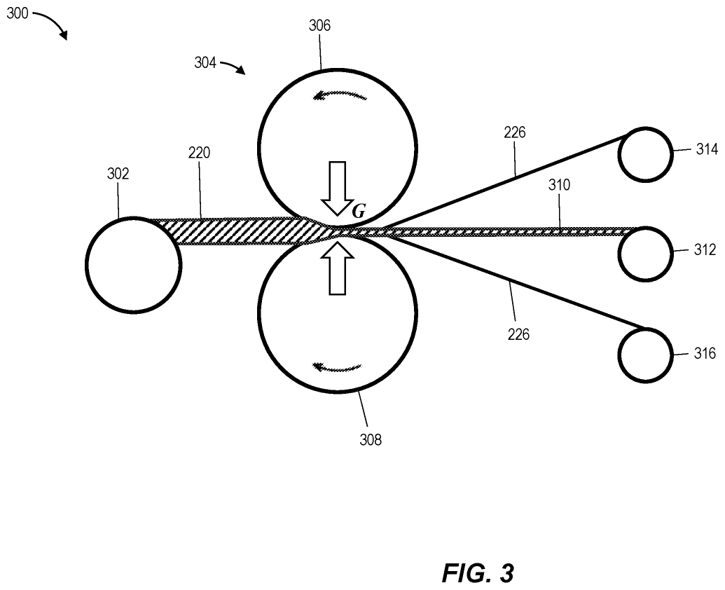

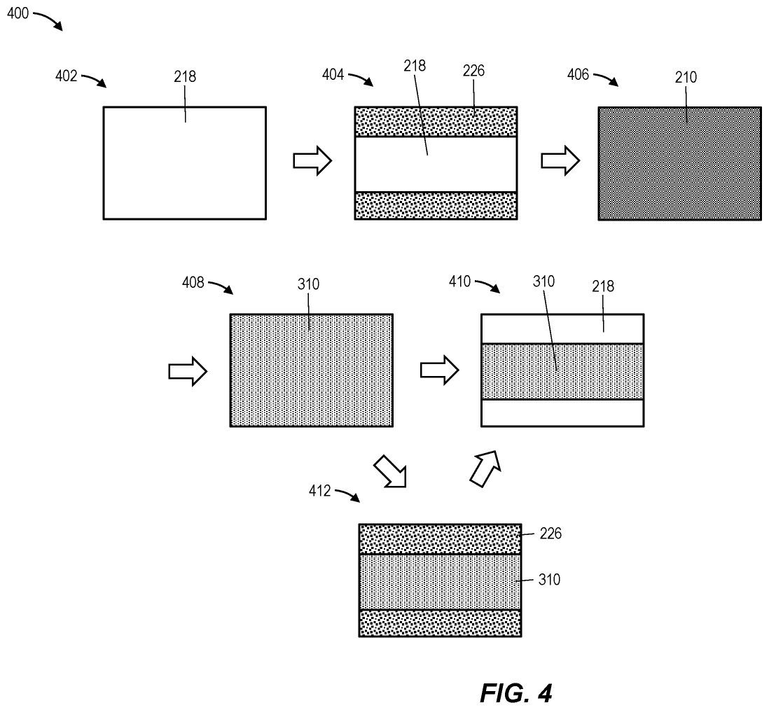

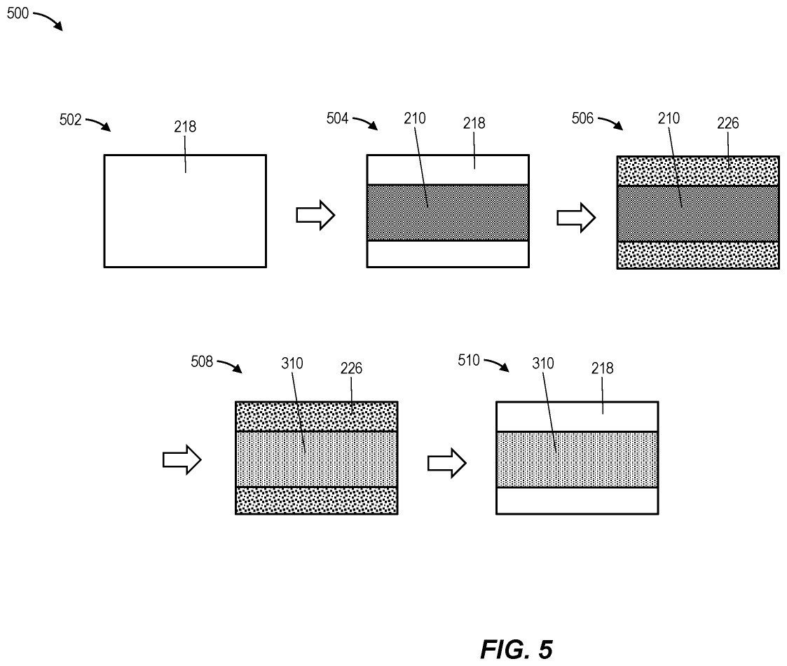

As will be detailed herein, the battery pack 108 includes a one or more cells having low porosity electrodes with enhanced edge quality (not separately shown). In some embodiments, an electrode coating system is modified to deposit support materials over portions of a current collector to evenly distribute stress during a calendering process (refer to FIG. 2). In some embodiments, an electrode calendering system is modified to remove the support materials after calendering (refer to FIG. 3). In some embodiments, the electrode coating system and the electrode calendering system together define an electrode assembly system. In some embodiments, the support materials are applied prior to coating the current collector and the support materials with electrode material (refer to FIG. 4). In some embodiments, the support materials are applied after coating the current collector with electrode material (refer to FIG. 5).

FIG. 2 illustrates an example configuration of an electrode coating system 200 in accordance with one or more embodiments. As shown in FIG. 2, the electrode coating system 200 can include a comma roll 202, a coating roll 204, and a back roll 206, configured and arranged as shown. The electrode coating system 200 is shown in a so-called reverse comma coating configuration for ease of discussion and illustration only. Other coating processes are possible, such as direct comma coating and slot die coating, and all such configurations are within the contemplated scope of this disclosure.

In some embodiments, the electrode coating system 200 includes a base plate 208 supporting thereon a film 210 and an active material supply 212 (also referred to as an electrode slurry and/or electrode material source). The electrode material in the active material supply 212 is not meant to be particularly limited, but can include, for example, various cathode or anode materials (depending on the requirements of a specific application), such as, for example, activated carbon powder, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), graphite, silicon, silicon-graphite composites, tin, tin oxide (SnO₂), lithium titanate (Li₄Ti₅O₁₂, LTO), sulfur and lithium-sulfur (Li-S) composites, lithium metal (Li), and/or lithium alloys such as lithium-antimony (Li-Sb), lithium-aluminum (Li-Al), and lithium-germanium (Li-Ge). The active material supply 212 can include, for example, a liquid supply dam (as shown), a semi-solid extrusion source, and/or a solids material supply, depending on the given process.

In some embodiments, the film 210 is wetted by the active material supply 212 as it passes through a gap 214 between the comma roll 202 and the coating roll 204. In some embodiments, the gap 214 can be adjusted by adjusting (e.g., hydraulically or otherwise) the relative positions of one or both of the comma roll 202 and the coating roll 204. The gap 214 controls the amount of material from the active material supply 212 which can be loaded onto the film 210.

In some embodiments, the electrode coating system 200 includes a cleaning blade 216 aligned to the coating roll 204. The cleaning blade 216 can be configured with an edge to remove any residue from the coating roll 204.

In some embodiments, the electrode coating system 200 includes a current collector 218 (also referred to as the web or bare foil) which is directed between the back roll 206 and the coating roll 204 and into contact with the coated film 213 (i.e., the electrode material). In this manner, electrode material can be applied continuously to a surface of the current collector 218 to define a coated current collector 220 (also referred to as the coated web). In some embodiments, the current collector 218 is a sheet of conductive metal, such as aluminum foil, stainless steel, and titanium foil, to which the coated film 210 is attached. Other materials are possible, such as, for example, semimetals (e.g., tin, graphite), and alloys of the metals and/or semimetals thereof.

In some embodiments, the coated current collector 220 can be passed directly to a calendering system (e.g., via a direct feed, not separately shown). In some embodiments, the coated current collector 220 can be passed indirectly to a calendering system (e.g., wound into a coated electrode roll prior to delivery to the calendering system, refer to FIG. 3).

As further shown in FIG. 2, the electrode coating system 200 can include one or both of a bare foil supporting material roll 222 and a coated foil supporting material roll 224.

In some embodiments, the bare foil supporting material roll 222 is configured to deposit and/or otherwise form a support material 226 on the current collector 218 prior to being coated with the electrode material (i.e., onto the bare foil). This configuration is discussed in greater detail with respect to FIG. 4.

In some embodiments, the coated foil supporting material roll 224 is configured to deposit and/or otherwise form a support material 226 on the current collector 218 after being coated with the electrode material (i.e., onto the coated foil). This configuration is discussed in greater detail with respect to FIG. 5.

Alternatively, or in addition, support material 226 can be placed (formed and/or deposited) directly onto a bare foil substrate without (or in addition to) direct integration within the electrode coating system 200 (not separately shown). For example, support material 226 can be formed onto bare foil upon receiving the foil roll and/or applied directly next to the coating prior to calendering (i.e., after forming the coated current collector 220 but prior to calendering as discussed with respect to FIG. 3). In some embodiments, support material 226 can be integrated directly into foil development and/or the coating process using additive manufacturing, such as 3D printing. For example, in some embodiments, the support material 226 can be printed directly onto a foil substrate as it is wound into a roll. Advantageously, this configuration decouples the application of the support material 226 from the electrode coating system 200, allowing for unique electrode coating patterns for various applications. In some embodiments, the support material 226 is applied using a cold spray to ensure adherence to the bare foil (e.g., in aluminum applications). In some embodiments, the support material 226 is printed from a source of powder material.

In some embodiments, the coated current collector 220 is flipped and passed back through the electrode coating system 200 a second time to coat the backside of the current collector 218 (i.e., a double-sided configuration, not separately shown). The backside of the current collector 218 can be coated and supporting material can be applied in a similar manner as discussed previously with respect to the first pass through the electrode coating system 200.

FIG. 3 illustrates an example configuration of an electrode calendering system 300 in accordance with one or more embodiments. As shown in FIG. 3, the electrode calendering system 300 can include a coated electrode roll 302. In some embodiments, the coated current collector 220 is wound into the coated electrode roll 302 following a coating process (refer to FIG. 2). In some embodiments, the coated current collector 220 is unwound from the coated electrode roll 302 and passed to a roll press 304 for calendering. Alternatively, in some embodiments, the coated current collector 220 is passed directly to the roll press 304.

In some embodiments, the roll press 304 includes a top roller 306 and a bottom roller 308 positioned to apply pressure onto the coated current collector 220. This process, known as calendering, is designed to improve the density, uniformity, and overall performance of the resulting pressed electrode 310 (i.e., the pressed current collector 218, coated film 210, and support material 226) by compressing and compacting the electrode material onto a portion of the current collector 218.

The top roller 306 and the bottom roller 308 can be made of a durable material, such as steel, and can be manufactured with precision surfaces (e.g., sub 10 micron tolerances) to ensure uniform pressure distribution. In some embodiments, the top roller 306 is positioned vertically above the bottom roller 308 and a gap G can be adjusted by moving (e.g., hydraulically) one or both of the top roller 306 and the bottom roller 308 to control the amount of pressure applied.

In some embodiments, the roll press 304 includes several control parameters, such as, for example, a roll temperature (top and/or bottom), a calendering pressure, a gap distance, and a line speed. In some embodiments, the roll temperature is 50 degrees Celsius, the pressure is 4.5 Mpa, and the line speed is 0.5 meters per minute, although other calendering configurations are within the contemplated scope of this disclosure. In some embodiments, the gap G can be adjusted to the desired thickness of the pressed electrode 310.

As the top roller 306 and/or the bottom roller 308 applies pressure, the coated current collector 220 is compressed. This helps improve the density of the pressed electrode 310, removes voids and air pockets, and enhances the contact between the electrode material (i.e., the coated film 210) and the current collector 218. The calendering process also results in a reduction in the thickness of the coated current collector 220, as the pressed electrode 310 is flattened under the pressure of the rollers.

In some embodiments, the presence of the support material 226 ensures that the stress applied to the bare foil portions of the current collector 218 is the same as the stress applied by the coated film 210 to the coated portions of the current collector 218. In some embodiments, a thickness of the support material 226 for a given application is selected to ensure the equal distribution of stresses. Observe that the thickness required to achieve a uniform stress distribution will vary based on the loading (e.g., milligrams per centimeter squared) and density of the electrode material, the material selected for the current collector 218, and the target thickness of the pressed electrode 310.

As further shown in FIG. 3, the electrode calendering system 300 can include a rewind roller 312. In some embodiments, the pressed electrode 310 is collected into one or more rolls using the rewind roller 312.

In some embodiments, the electrode calendering system 300 can include a top support material rewind roller 314 and/or a bottom support material rewind roller 316 (also referred to as collection rollers), depending on whether a given application uses a single-sided or double-sided coating configuration (refer to FIG. 2). In some embodiments, the top support material rewind roller 314 is configured to recover the support material 226 placed and/or formed on the top surface of the pressed electrode 310. In some embodiments, the bottom support material rewind roller 316 is configured to recover the support material 226 placed and/or formed on the bottom surface of the pressed electrode 310. In some embodiments, the top support material rewind roller 314 and the bottom support material rewind roller 316 are configured to collect the support material 226 prior to recovery of the pressed electrode 310 by the rewind roller 312.

FIG. 4 illustrates a process workflow 400 for manufacturing electrodes with enhanced edge quality in accordance with one or more embodiments. The process workflow 400 describes a first manufacturing type whereby a support material is deposited onto a current collector prior to coating with an electrode material. The workflow 400 can be carried out as part of an electrode coating (refer to FIG. 2) and calendering process (refer to FIG. 3).

The workflow 400 begins at Step 402, where a current collector 218 is sourced for coating/calendering. In some embodiments, the current collector 218 is provided as a sheet or foil which is passed between a back roll 206 and a coating roll 204 for contact with electrode material as described previously with respect to FIG. 2.

At Step 404, a support material 226 is applied onto a surface of the current collector 218. In some embodiments, the support material 226 is applied to portions of the current collector 218 which will be bare foil in the final, pressed electrode (i.e., those portions not covered with electrode material). In some embodiments, the support material 226 is formed to a thickness selected such that later calendering stresses (refer to Step 408) are equal (or substantially equal within tooling limits) in both bare and coated portions of the current collector 218.

In some embodiments, the support material 226 is deposited and/or formed as a single material layer. In some embodiments, the support material 226 is deposited and/or formed as two or more stacked material layers. In some embodiments, additional layers of the support material 226 can be stacked to target a desired thickness.

In some embodiments, the support material 226 can include an adhesive component and/or a protective coating. In some embodiments, the support material 226 includes a material selected for thermal stability. For example, the support material 226 can include a material(s) that are thermally stable up to 150 degrees Celsius. In some embodiments, the support material 226 includes an adhesive that can adhere to the current collector 218 while also being removable without leaving a residue. In some embodiments, the support material 226 includes a material selected for resistances to the slurry chemical composition (e.g., NMP, water, etc.) of a given application. In some embodiments, the support material 226 includes a material selected for shelf stability (e.g., maintains characteristics for 6 months, 1 year, etc.). In some embodiments, the support material 226 includes a material that is impermeable to the electrode slurry. In some embodiments, the support material 226 includes a material that is compressible at the calendering pressures applicable for a given application. For example, in scenarios where 4.5 Mpa pressure is required to reduce an electrode thickness by 100 micros, the support material 226 can include materials having a Young's modulus of 45 Gpa or more. Example materials include, but are not limited to, tapes and/or composites of polyimide, flexible polymers, silicone-based adhesives, polytetrafluoroethylene (PTFE), polyvinyl chloride (PVC), PVC carriers coated with adhesive materials, and metal foil.

At Step 406, the current collector 218 and the support material 226 are coated with electrode material (e.g., the coated film 210). The current collector 218 can be coated using a coating system (e.g., the electrode coating system 200 described with respect to FIG. 2).

At Step 408, the current collector 218, the support material 226, and the coated film 210 are compressed using a calendering system (e.g., the electrode calendering system 300 described with respect to FIG. 3) to produce a pressed electrode 310. Advantageously, the support material 226 serves to more evenly distribute calendering stresses during this process, resulting in reduced wrinkling effects and enhanced edge quality in the pressed electrode 310.

At Step 410, the support material 226 (and portions of the pressed electrode 310 formed thereon) is removed to reveal a bare foil portion of the current collector 218. The support material 226 can be removed using collection rollers (e.g., the top support material rewind roller 314 and/or the bottom support material rewind roller 316), as described previously.

Optionally, the workflow 400 can include a Step 412 inserted between Step 408 and Step 410. At Step 412, an additional layer of the support material 226 is applied to portions of the pressed electrode 310 over the initial, first layer of the support material 226. In this configuration, the workflow 400 proceeds to Step 410, where both the initial layer and the additional layer of the support material 226 are removed. Advantageously, the additional layer of the support material 226 serves to further support the removal of portions of the pressed electrode 310.

FIG. 5 illustrates a process workflow 500 for manufacturing electrodes with enhanced edge quality in accordance with one or more embodiments. The process workflow 500 describes a second manufacturing type whereby a support material is deposited onto a current collector after coating with an electrode material. The workflow 500 can be carried out as part of an electrode coating (refer to FIG. 2) and calendering process (refer to FIG. 3).

The workflow 500 begins at Step 502, where a current collector 218 is sourced for coating/calendering. In some embodiments, the current collector 218 is provided as a sheet or foil which is passed between a back roll 206 and a coating roll 204 for contact with electrode material as described previously with respect to FIG. 2.

At Step 504, a portion of the current collector 218 is coated with electrode material (e.g., the coated film 210). The current collector 218 can be coated using a coating system (e.g., the electrode coating system 200 described with respect to FIG. 2).

At Step 506, a support material 226 is applied onto a bare surface of the current collector 218 (i.e., those portions not coated during Step 504). In some embodiments, the support material 226 is formed to a thickness selected such that later calendering stresses (refer to Step 508) are equal (or substantially equal within tooling limits) in both bare and coated portions of the current collector 218. The support material 226 can be deposited and/or formed as a single material layer or as two or more stacked material layers, and can include an adhesive component and/or a protective coating, as described previously.

At Step 508, the current collector 218, the support material 226, and the coated film 210 are compressed using a calendering system (e.g., the electrode calendering system 300 described with respect to FIG. 3) to produce a pressed electrode 310. Advantageously, the support material 226 serves to more evenly distribute calendering stresses during this process, resulting in reduced wrinkling effects and enhanced edge quality in the pressed electrode 310.

At Step 510, the support material 226 (and portions of the pressed electrode 310 formed thereon) is removed to reveal a bare foil portion of the current collector 218. The support material 226 can be removed using collection rollers (e.g., the top support material rewind roller 314 and/or the bottom support material rewind roller 316), as described previously.

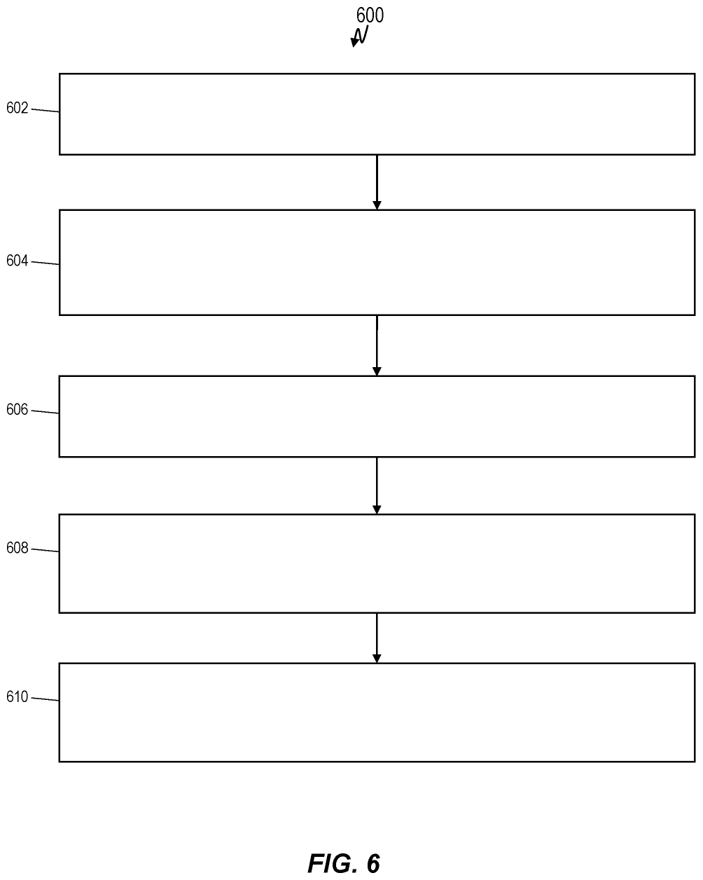

Referring now to FIG. 6, a flowchart 600 for manufacturing electrodes with enhanced edge quality is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes providing a current collector.

At block 604, the method includes applying a support material onto a first portion of the current collector. In some embodiments, the support material is applied at a thickness selected to evenly distribute calendering stress across bare portions and coated portions of the current collector. In some embodiments, the support material includes one or more of a polyimide, a polymer, a silicone-based adhesive, PTFE, PVC, and metal foil.

In some embodiments, applying the support material onto the first portion of the current collector includes providing a bare foil supporting material roll positioned to apply the support material onto the first portion of the current collector prior to the current collector being coated with the electrode material.

At block 606, the method includes coating the current collector and the support material with an electrode material. In some embodiments, coating the current collector and the support material with the electrode material includes providing a liquid supply dam including the electrode material and providing a coating roll coupled to the liquid supply dam. The coating roll is positioned to coat the current collector with the electrode material.

At block 608, the method includes calendering the current collector, the support material, and the electrode material.

In some embodiments, the method includes applying additional support material over the first portion of the current collector after calendering. In some embodiments, the additional support material is applied directly onto the electrode material.

At block 610, the method includes removing the support material from the first portion of the current collector.

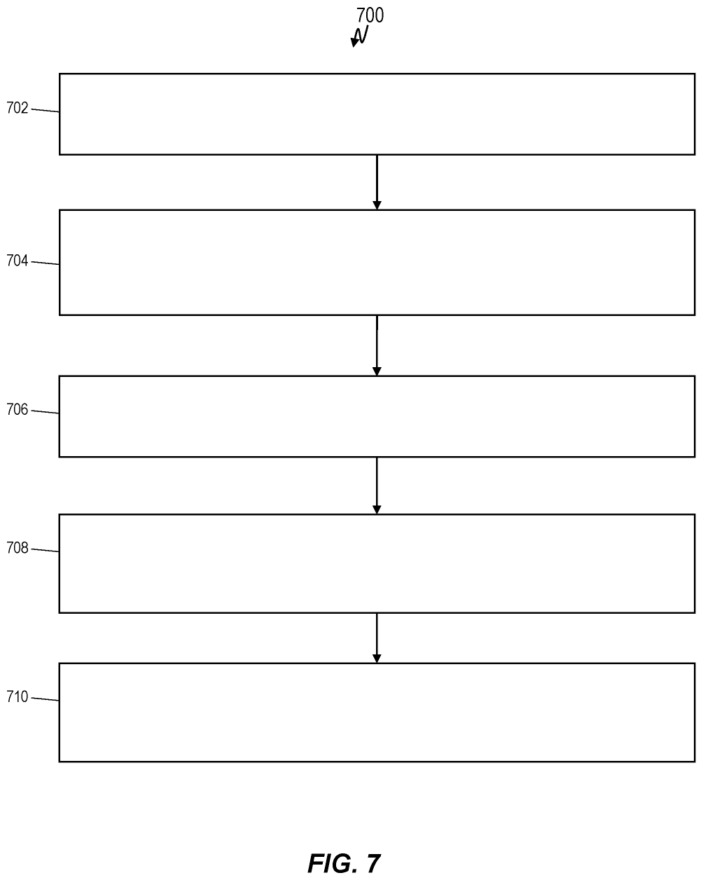

Referring now to FIG. 7, a flowchart 700 for manufacturing electrodes with enhanced edge quality is generally shown according to an embodiment. The flowchart 700 is described in reference to FIGS. 1-5 and may include additional steps not depicted in FIG. 7. Although depicted in a particular order, the blocks depicted in FIG. 7 can be rearranged, subdivided, and/or combined.

At block 702, the method includes providing a current collector.

At block 704, the method includes coating a first portion of the current collector with an electrode material. In some embodiments, coating the first portion of the current collector with the electrode material includes providing a liquid supply dam including the electrode material and providing a coating roll coupled to the liquid supply dam. The coating roll is positioned to coat the current collector with the electrode material.

At block 706, the method includes applying a support material onto a second portion of the current collector. In some embodiments, the support material is applied at a thickness selected to evenly distribute calendering stress across the first portion and the second portion of the current collector. In some embodiments, the support material includes one or more of a polyimide, a polymer, a silicone-based adhesive, PTFE, PVC, and metal foil.

In some embodiments, applying the support material onto the second portion of the current collector includes providing a coated foil supporting material roll positioned to apply the support material onto the second portion of the current collector after the first portion of the current collector is coated with the electrode material.

At block 708, the method includes calendering the current collector, the support material, and the electrode material.

At block 710, the method includes removing the support material from the second portion of the current collector. In some embodiments, removing the support material includes providing a top support material rewind roller positioned to recover the support material from a top surface of the current collector. In some embodiments, removing the support material further includes providing a bottom support material rewind roller positioned to recover the support material from a bottom surface of the current collector.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for manufacturing electrodes with enhanced edge quality, the system comprising:
an active material supply comprising an electrode material;
a coating roll coupled to the active material supply, the coating roll positioned to coat a current collector with the electrode material;
a back roll positioned to transfer the current collector to the coating roll; and
at least one of a bare foil supporting material roll and a coated foil supporting material roll;
wherein the bare foil supporting material roll is positioned to apply a support material onto a first portion of the current collector prior to the current collector being coated with the electrode material;
wherein the coated foil supporting material roll is positioned to apply the support material onto the first portion of the current collector after the current collector is coated with the electrode material; and
wherein the support material is applied at a thickness selected to evenly distribute stress across bare portions and coated portions of the current collector during a calendering process, thereby forming a pressed electrode having enhanced edge quality.

2. The system of claim 1, further comprising one or more collection rollers positioned to recover the support material after the calendering process.

3. The system of claim 2, wherein the one or more collection rollers comprises a top support material rewind roller positioned to recover the support material from a top surface of the pressed electrode.

4. The system of claim 3, wherein the one or more collection rollers further comprises a bottom support material rewind roller positioned to recover the support material from a bottom surface of the pressed electrode.

5. The system of claim 1, wherein the support material comprises one or more of a polyimide, a polymer, a silicone-based adhesive, polytetrafluoroethylene (PTFE), polyvinyl chloride (PVC), and metal foil.

6. The system of claim 1, further comprising a comma roll separated from the coating roll by a gap, the gap defining an amount of the electrode material coated onto the current collector.

7. A method comprising:
providing a current collector;
applying a support material onto a first portion of the current collector;
coating the current collector and the support material with an electrode material;
calendering the current collector, the support material, and the electrode material; and
removing the support material from the first portion of the current collector.

8. The method of claim 7, wherein the support material is applied at a thickness selected to evenly distribute calendering stress across bare portions and coated portions of the current collector.

9. The method of claim 7, further comprising applying additional support material over the first portion of the current collector after calendering.

10. The method of claim 9, wherein the additional support material is applied directly onto the electrode material.

11. The method of claim 7, wherein the support material comprises one or more of a polyimide, a polymer, a silicone-based adhesive, polytetrafluoroethylene (PTFE), polyvinyl chloride (PVC), and metal foil.

12. The method of claim 7, wherein applying the support material onto the first portion of the current collector comprises providing a bare foil supporting material roll positioned to apply the support material onto the first portion of the current collector prior to the current collector being coated with the electrode material.

13. The method of claim 7, wherein coating the current collector and the support material with the electrode material comprises:
providing an active material supply comprising the electrode material; and
providing a coating roll coupled to the active material supply, the coating roll positioned to coat the current collector with the electrode material.

14. A method comprising:
providing a current collector;
coating a first portion of the current collector with an electrode material;
applying a support material onto a second portion of the current collector;
calendering the current collector, the support material, and the electrode material; and
removing the support material from the second portion of the current collector.

15. The method of claim 14, wherein the support material is applied at a thickness selected to evenly distribute calendering stress across the first portion and the second portion of the current collector.

16. The method of claim 14, wherein the support material comprises one or more of a polyimide, a polymer, a silicone-based adhesive, polytetrafluoroethylene (PTFE), polyvinyl chloride (PVC), and metal foil.

17. The method of claim 14, wherein applying the support material onto the second portion of the current collector comprises providing a coated foil supporting material roll positioned to apply the support material onto the second portion of the current collector after the first portion of the current collector is coated with the electrode material.

18. The method of claim 14, wherein coating the first portion of the current collector with the electrode material comprises:
providing an active material supply comprising the electrode material; and
providing a coating roll coupled to the active material supply, the coating roll positioned to coat the current collector with the electrode material.

19. The method of claim 14, wherein removing the support material comprises providing a top support material rewind roller positioned to recover the support material from a top surface of the current collector.

20. The method of claim 19, wherein removing the support material further comprises providing a bottom support material rewind roller positioned to recover the support material from a bottom surface of the current collector.
